(19) United States
(12) Patent Application Publication
(10) Pub. No.: US 2024/0202943 A1
(43) Pub. Date: Jun. 20, 2024

(54) CBCT SIMULATION FOR CT-TO-CBCT REGISTRATION AND CBCT SEGMENTATION

(71) Applicant: KONINKLIJKE PHILIPS N.V., EINDHOVEN (NL)

(72) Inventors: ALEXANDER SCHMIDT-RICHBERG, HAMBURG (DE); SVEN PETER PREVRHAL, HAMBURG (DE); RAFAEL WIEMKER, KISDORF (DE); TOBIAS KLINDER, UELZEN (DE); HEIKE CAROLUS, AHRENSBURG (DE); DIRK SCHAEFER, HAMBURG (DE)

(21) Appl. No.: 18/539,976

(22) Filed: Dec. 14, 2023

(30) Foreign Application Priority Data
Dec. 16, 2022 (EP) 22214132.7

(51) Int. Cl. G06T 7/30; G06T 7/11; G06T 11/00

(52) U.S. Cl. CPC G06T 7/30; G06T 7/11; G06T 11/006; G06T 2207/10081; G06T 2207/20081; G06T 2210/41

(57) ABSTRACT

The present invention relates to a computer-implemented method for generating a simulated CBCT image based on a computed tomography image. A computed tomography image is converted into attenuation coefficients of the represented tissue, and the computed tomography image is forward-projected to a projection image based on scanner parameters of a simulated CBCT scanner. After the addition of artificial noise to the projection image representing noise detected by the simulated CBCT scanner, the projection image is back-projected with a reconstruction algorithm for the generation of a simulated CBCT image of the subject. The present invention relates further to a method for generating training data for training an artificial intelligence module based on the simulated images, and to methods for registering a computed tomography image to a CBCT image and for segmenting a CBCT image with an artificial intelligence module trained with training data comprising the simulated CBCT images.

### FIELD

The present application describes various embodiments related to generating a simulated cone-beam computed tomography (CBCT) image based on a computed tomography (CT) image, a computer-implemented method for generating training data for training of an artificial intelligence (AI) module to register a CBCT image to a CT image, a computer-implemented method for registering a CT image to a CBCT image, a computer-implemented method for segmenting a CBCT image, a data processing apparatus, a computer program, and a computer-readable storage medium.

### BACKGROUND

The registration of computed tomography (CT) to cone-beam CT (CBCT) images as well as the segmentation of intra-operative C-arm CBCT images is a recurring task in many medical applications and image-guided interventions. For example, diagnostic CT scans are aligned with intra-operative CBCT scans to map intervention plans to the patient coordinate system for radiation therapy or guided percutaneous needle interventions. Further, the automatic segmentation of anatomical structures in CBCT images is a pre-requisite for many interventional applications. For example, the kidney parenchyma and surrounding organs-at-risk are delineated for radiation therapy or guided percutaneous needle interventions. The segmentation of CBCT images is challenging due to the limited field of view and occurring image artifacts in the CBCT images. In recent years, artificial intelligence (AI)-based registration methods of CT images to CBCT images and AI-based segmentation methods have gained popularity, as AI-based methods have proven to be superior or at least on par to conventional non-AI-based approaches with respect to speed and accuracy. AI-based training methods can be divided into supervised and semi-supervised methods.

However, while supervised training algorithms help improve the target deformation, ground-truth transformations are usually unknown and therefore not available during training. Therefore, this technique is usually only applied for mono-modal registration tasks with synthetic transformations as ground truth. As a remedy, semi-supervised methods may search for the target deformation by formulating several conditions such as, for example, smoothness and optimizing these conditions. However, formulating meaningful conditions can be challenging. Also training such algorithms use a significant amount of available training image pairs specific to the application at hand. Therefore, a substantial amount of appropriate training data is required to train such algorithms. Access to large data collections is one of the main challenges of AI-based algorithm development. For CT images, large public databases, which may in part be longitudinal, exist that can be employed to train neural networks. However, this is not the case for CBCT data as abdominal CBCT, for example, is not the norm in clinical diagnostic imaging and patients cannot be unnecessarily exposed to radiation. At the same time, to achieve a comparable accuracy and robustness, even more data as for CT data would typically be needed to compensate for the increased variability of the data of CBCTCBCT images, such as positioning, a limited field of view, non-quantitative modality, image artifacts, etc.

### SUMMARY

Various embodiments described herein provide more accurate training data and the possibility to train artificial intelligence (AI)-based algorithms with such data, leading to more robust models.

The embodiments similarly pertain to the computer-implemented method for generating a simulated cone-beam computed tomography (CBCT) image based on a computed tomography (CT) image, the computer-implemented method for generating training data for training of an artificial intelligence (AI) module to register a CBCT image to a CT image, the computer-implemented method for registering a CT image to a CBCT image, the computer-implemented method for segmenting a CBCT image, the data processing apparatus, the computer program, and the computer-readable storage medium.

The embodiments described further may be combined in various ways. Synergistic effects may arise from different combinations of the embodiments as well.

The application describes a computer-implemented method for generating a simulated CBCTCBCT image based on a CT image. The method comprises the step of receiving data representing a CT image of a subject. The data may be directly acquired by a computed tomography scanner and transmitted from the same, or downloaded from a cloud storage, or obtained from a DICOM station, or in any other possible way. The CT image comprises a volume of the subject being divided into a plurality of voxels, the voxels comprising a representation of a tissue property of a tissue of the subject in Hounsfield Units (HU). The method further comprises the steps of converting the HU of a voxel of the CT image into attenuation coefficients, receiving scanner parameters, which may be predetermined, of a simulated CBCT scanner, and forward-projecting the CT image to a projection image based on the scanner parameters of the simulated CBCT scanner. The method further comprises the steps of adding artificial noise to the projection image, the artificial noise being a representation of noise detected by the simulated CBCT scanner, back-projecting the projection image with a reconstruction algorithm, thereby generating a simulated CBCT image of the subject, and providing the simulated CBCT image of the subject.

Thus, a physical simulation of CBCT images from CT scans is proposed to formulate a new registration approach for CT-to-CBCT registration, and to train neural networks for CBCT segmentation. In this way the high requirements on the training data can be mitigated and already-trained CT models can be adapted more easily to the new data of CBCT scanners. Since CT data are more available in clinical practice than CBCT data, the proposed solution would help in solving data scarcity. Thus, the problem of scarcity of data for CBCT protocol training is addressed by providing an algorithm that uses CT scans to produce realistic simulations of CBCT data. This allows to utilize widely available CT data sources to create a CBCT data set that covers a wide range of anatomical variations, scan positions, field of view, and parameter settings. With this approach, and the simulated CBCT data, a supervised or unsupervised training of CT-to-CBCT registration algorithms can be employed, as well as an AI-based segmentation of CBCT images.

One aspect of various embodiments is an algorithm that simulates a CBCT scan from a given CT scan. It is worth to note that due to the image generation process for the CBCT image is known, any annotation, for example via a voxel-based segmentation, existing in the CT image can be transferred to the CBCT image, as there is no need for an additional annotation.

An image simulation method for simulating data from one imaging modality to another imaging modality is provided. A detailed description of the main elements is given in the following. The simulation algorithm does a physical simulation of a CBCT scan based on a CT scan. This involves receiving a computed tomography image of a subject acquired by a computed tomography scanner. The subject can be a patient, a human or an animal, and the acquired image can depict at least a part of the subject or patient. Alternatively, the term of the subject can be understood as describing only a part of the patient, for example, in case the acquired image provides a limited field of view. A subject can also be an anatomical area of interest or a positioning of the imaging system, as CBCT usually does not capture the whole subject. Thus, the subject has to be interpreted broadly. The computed tomography image describes a volume of the subject divided into a plurality of voxels, the voxels comprising a representation of a tissue property of a tissue of the subject in Hounsfield Units. The tissue property may be a measure of the opacity of the tissue with respect to X-ray radiation of a certain wavelength, for example. The Hounsfield Units of a voxel of the computed tomography image may be converted into a corresponding tissue-specific attenuation coefficient of the tissue by identifying tissue classes such as bone, stone, soft tissue, blood, and contrast media. This attenuation coefficient may be given as a function of the energy of the X-ray radiation.

After receiving scanner parameters, which may be predetermined, of a simulated CBCT scanner, the CT image is forward projected based on the scanner parameters of the simulated CBCT scanner. These scanner parameters may comprise a location of the scanner with respect to the patent, a rotation angle, scatter properties, beam-hardening effects, or detector deficiencies, for example. In some embodiments, the attenuation coefficients can be used for the forward projection to create the raw data. The representation of the raw data itself can be in different units (e.g., attenuation/line integral space). The units for the representation of the raw data depend on the type of noise that is desired to be added in subsequent step(s).

In a next step, artificial noise is added to the projection image in the projection space. This noise may represent electronic noise of the detector of the simulated CBCT scanner, for example, or cross-talk between neighboring detector channels. Further, the forward-projected projection image with added noise is back-projected with a given reconstruction algorithm and scanner parameters specific to the simulated CBCT scanner, such as resolution, for example.

As the field of view of a CBCT is generally different, usually smaller, than that of the CT, the reconstruction algorithm may comprise a cropped field of view. Examples of reconstruction algorithms include, for example, distributed compressed sensing (DCS). Feldkamp-David-Kress (FDK), or other similar algorithms. The back-projected simulated CBCT image may be provided to a user, or for further processing. Hence, this invention proposes to use physical simulation of CBCT images from CT scans. These images may be used to formulate a new supervised registration approach for CT-to-CBCT registration, or for training an AI-based segmentation of CBCT images.

As illustrated, a broad set of parameters can be used. All parameters can be chosen to either cover a wide range of scanners or protocols, or to optimize the application to one specific protocol and/or reconstruction algorithm.

In an embodiment of the invention, the method further comprises the step of modifying the tissue property of the tissue of the subject. Thus, modified tissue classes can comprise the addition of renal stones or their composition, or spinal bone density can be increased. Further, it may be possible to assign a blood class to contrast media in the CT image, in order to simulate an acquired image without injected contrast media.

In a further embodiment, spectral image guided therapy systems akin to spectral CT scanners can be introduced. Several types of renal stones with strongly differing chemical compositions are known to have a distinctive spectral CT signature. Simulation of CBCT acquisition of such stones in anatomically natural locations will allow development of proof points and appropriate scan and reconstruction protocols much faster and more comprehensively as actual in vivo scanning.

Thus, typical application-specific artefacts hampering the correct segmentation or registration can be integrated in the simulation, e.g., in the intra-procedural CBCT volume, the outline of the kidneys may be corrupted by streak artefacts originating from high iodine concentrations in the urinary outflow tract. The simulation of the physical effects and their current (imperfect) correction leads to typical CBCT volumes that can be used for the supervised training of AI-based approaches. Thus, an AI-based algorithm can be trained to determine chemical compositions according to CT. CBCT or PET (Positron Emission Tomography) data. Key applications of such a technique can be demonstrated.

In an embodiment of the invention, the scanner parameters comprise at least two tube peak voltages of the simulated CBCT scanner. Thus, poly-energetic forward projection at two or more assumed tube peak voltages can be implemented into the simulation to effect spectral or dual-energy CBCT simulations. The forward projection of the CT image based on the scanner parameters of the simulated CBCT scanner can be poly-energetic. Thus, the scanner parameters may comprise, besides location, rotation angle, scatter, beam-hardening effects, or detector deficiencies, for example, also detection parameters of poly-energetic X-ray radiation. In addition or alternatively to the simulation of different tube peak voltage (kVp) settings of the simulated X-ray source, the detector can be modelled to be energy-selective. In some embodiments, the attenuation coefficients can be used for the forward projection to create the raw data. The representation of the raw data itself can be in different units (e.g., attenuation/line integral space). The units for the representation of the raw data depend on the type of noise that is desired to be added in subsequent step(s).

In an embodiment of the invention, the computed tomography image is a fan-beam computed tomography image or a CBCT image. Thus, the simulation of CBCT images can be done either based on images acquired with a conventional fan-beam computer tomography scanner, or based on images acquired with a CBCT scanner. Thus, it is possible to utilize the widely available data of conventional CT images, or to provide training data for AI-based CBCT-to-CBCT registration, for example for intervention success control checks and outcome monitoring.

According to another aspect of various embodiments, there is provided a computer-implemented method for generating training data for training of an AI module to register a CBCT image to a computed tomography image. The method comprises the steps of receiving data representing a first computed tomography image of a subject, generating data representing a second computed tomography image of the subject, wherein the second computed tomography image differs from the first computed tomography image in that a transformation is applied to the second computed tomography image, the transformation comprising a deformation, and/or distortion, and/or rotation, and/or translation of the subject, and/or a cropped field of view, and generating data representing the transformation. The method comprises further the steps of generating a simulated CBCT image based on one of the first computed tomography image and the second computed tomography image according to the method of any of the preceding embodiments, wherein the data representing the computed tomography image comprises the first and/or the second computed tomography image, and generating a set of training data, the set of training data comprising the simulated CBCT image based on one of the first computed tomography image and the second computed tomography image, the other one of the first computed tomography image and the second computed tomography image, and data representing the transformation. Further, the set of training data is provided.

Thus, with the training data provided with this proposed method, a registration approach may be trained to predict a transformation T′:=y(I,J) given two images I, J and a ground truth transformation T by minimizing a loss function L(T,T′). Thereby, one of the images I, J is preferably a CT image, while the other one of the images I, J is a CBCT image. Therefore, data representing a first computed tomography image and a second computed tomography image have to be provided. It may be necessary, that the first computed tomography image and the second computed tomography image are images from the same subject. In alternative embodiments, it may be sufficient that the first computed tomography image and the second computed tomography image are images from a corresponding body part of different patients. However, the first CT image and the second CT image need to represent at least a similar body part of as subject, preferably the same body part of the same patient acquired with a similar field of view. For training purposes, it may be necessary that there is a transformation between the first CT image and the second CT image. The transformation can be a deformation, distortion, rotation, and/or translation of the subject or the image, and/or a cropped field of view of the image. The field of view of a CBCT is generally different, usually smaller, than that of a CT. In addition to the patient being rotated, translated, etc., the CBCT imager may be at a position different from that of the CT gantry. Having these two CT images available, together with data representing the underlying transformation, one of the first CT image and the second CT image is used as basis for generating a simulated CBCT image according to the method described above. A set of training data generated with the method according to the present invention comprises the generated simulated CBCT image, together with the CT image of the two CT images that is not used for generating the simulated CBCT image, and the data representing the transformation as ground truth. An AI-based registration algorithm may be trained to predict a transformation T′ given as image I the first CT image, a CBCT simulated image based on the second CT image as image J. and the ground truth transformation T by minimizing a loss function L(T,T′).

Based on this, two main approaches for training an AI-based registration algorithm can be followed depending on the target application and data availability. There might be at least two strategies for collecting information for providing the set of training data, and in particular the first CT image and the second CT image with the respective transformation T as ground truth. For instance, in a first embodiment, a real transformation T is computed by registration of two CT images I and J as first CT image and second CT image. These can be, for example, two longitudinal scans or inhale/exhale image pairs of the same subject. The transformation T can be determined by conventional registration methods applied to images I and J. After using one of the images I and J as basis for generating a simulated CBCT image, a set of training data can be provided. The set of training data comprises the generated simulated CBCT image based on one of the CT images I and J, the other one of the CT images I and J. and data representing the transformation provided by the registration. Thus, an AI-based algorithm can be trained to predict T′ based on I and J^{CBCT}, together with T as ground truth by minimizing the loss function L(T,T′).

In an alternative embodiment an artificial transformation T is applied to transform to a first CT image, thereby generating the second CT image. After that, one of these CT images is used as basis for generating the simulated CBCT image. As the transformation is artificially applied to the CT image, data representing the transformation are known. Thus, the AI-based algorithm can be trained to estimate T′ based on image I as the first CT image, image J=I_{T}^{CBCT}. i.e. a generation of a simulated CBCT image based on the image I with the applied artificial transformation T. and the known data representing the transformation T.

In an embodiment of the invention, the step of generating data representing a second computed tomography image of the subject comprises receiving data representing the second computed tomography image of the subject. In this scenario, there are scan pairs comprising a real transformation, wherein pairs of CT scans are regarded. e.g. pre- and post-operative scans, longitudinal scans at different time points, or inhale/exhale pairs of a patient. The pair of CT scans can be acquired from the same patient at different points in time or at different circumstances. However, it may even be possible to utilize scan pairs acquired from different patients, where the scan pairs depict a similar region of the bodies of the patients, for learning inter-subject registration.

In an embodiment of the invention, the step of generating data representing the transformation comprises registering the first computed tomography image to the second computed tomography image. Thus, a real transformation T is computed by registration of two CT images I and J. These can be, e.g., two longitudinal scans or inhale/exhale pairs of the same subject. Then, an algorithm can be trained to predict T′ based on I and J^{CBCT}, together with the computed transformation T as ground truth. This scenario strongly depends on the accuracy of the underlying registration algorithm, which sets the lower bound on the expected accuracy. However, for many applications CT-CT registration has been shown to be extremely accurate and generally less challenging than CT-CBCT registration.

In an embodiment of the invention, the registering of the first computed tomography image to the second computed tomography image is performed with a conventional or an AI-based registering algorithm. Thus, the ground truth transformation can be determined by registering the scans using an existing, e.g., conventional, registration algorithm. Alternatively, a common AI-based registration algorithm registering two CT images can be applied.

In an embodiment of the invention, the step of generating data representing a second computed tomography image of the subject comprises applying an artificial transformation to the data representing the first computed tomography image of the subject thereby generating data representing the second computed tomography image of the subject.

In this scenario, there is one first CT image acquired with a single CT scan available, on which an artificial transformations is performed that deforms the CT image, thus providing a second CT image. A random artificial transformation can be used to deform the CT scan before CBCT simulation. Depending on the application, different transformation models can be selected to generate the random transformation. For a simple coarse alignment of CT and CBCT scan, affine transformations can be selected. In this case, the trained network would predict parameters defining the transformation, e.g., rotation angles, translation vector, etc. If more complex deformations between the images are to be expected, dense transformation fields can be generated using, for example, radial basis functions or biophysical models, for example, to learn the registration of inhale and exhale scans. In a specific embodiment, the transformation T could be chosen not randomly but stem from a former registration with any other (intra- or inter-patient) dataset. In this way, the domain of T would consist of realistic transformations, but requirements on the available data would be higher. The generation of a simulated CBCT image can be performed with either of the CT images. It is easy to collect training data in this scenario, because only single scans are required. However, the applicability depends on the transformation model. In addition, only spatial deformations between the scans may be present in the training data, without any longitudinal changes. The artificial transformation T can be applied to transform the CT image I before the generation of the simulated CBCT image, thereby deriving image J: Image J=I_{T}^{CBCT}:=(I∘T) CBCT. An AI-based algorithm can be trained to estimate T′ based on I, J. and T.

In an embodiment of the invention, the step of generating data representing the transformation comprises receiving data representing the artificial transformation. Thus, as the data representing the artificial transformation are known per se, there is no separate determination of the transformation necessary.

According to another aspect of various embodiments, there is provided a computer-implemented method for registering a computed tomography image to a CBCT image. The method comprises the steps of receiving data representing a computed tomography image of a subject, receiving data representing a CBCT image of the subject, and determining a transformation necessary for registering the computed tomography image to the CBCT image using an AI module, wherein the AI module is trained with training data generated with the method according to any of the preceding embodiments. The method comprises further the steps of registering the computed tomography image to the CBCT image according to the determined transformation, and providing the computed tomography image registered to the CBCT.

This method can be applied in all applications that include CT-to-CBCT registration, e.g., for image-guided lung, liver, or kidney interventions, and offers a faster and more reliable approach for registering the images close to real time. In a supervised registration approach, the artificial intelligence module can be trained to predict a transformation T′=y(I,J) given the two images I, J and a ground truth transformation T as set of training data by minimizing a loss function L(T,T′). At least one of the images I and J is a simulated CBCT image generated by the simulation method as described above.

According to another aspect of various embodiments, there is provided a computer-implemented method for segmenting a CBCT image. The method comprises the steps of receiving data representing a CBCT image of a subject acquired by a CBCT scanner, segmenting the CBCT image using an artificial intelligence module, wherein the artificial intelligence module is trained with training data comprising a plurality of simulated CBCT images generated with the method according to any of the preceding embodiments, and providing the segmented CBCT image.

Thus, an AI-based segmentation can be trained to segment anatomical structures in CBCT images using simulated CBCT data generated with the simulation method as described above.

In an embodiment of the invention, the training data comprises a plurality of computed tomography images acquired with a computed tomography scanner and/or a plurality of CBCT images acquired with a CBCT scanner.

The final training dataset for a preferably supervised training can have different compositions. In a first composition, only simulated CBCT data are used. In this embodiment, a set of CT images is collected and one or multiple CBCT scans are simulated for a CT scan using different parameter settings, such as scanner positioning, noise level, etc. In this way, a model specific to (simulated) CBCT data is trained. In a second composition of the training data set. CT images and simulated CBCT images are used. In this embodiment, original CT scans can also be used during training. In this way, a rather generic CT-CBCT model capable of segmenting both CT and (simulated) CBCT data is trained. In a third composition of the training data set. CT images, simulated CBCT images and real CBCT data are used. Additionally, real CBCT data can be used to incorporate properties of the data that cannot be covered by the simulation, e.g., specific types of image artifacts, devices, or surgical scenarios.

In addition or alternatively, simulated CBCT data can be used to pre-train a model for a specific task, which is then refined by training the model a few further epochs using clinical CBCT data for domain adaptation. Compared to a CT-only pre-trained model, this model must adapt to only specific image properties of the CBCT data, e.g., the characteristic signal-to-noise ratio, while others, e.g., the limited field of view, have already been accounted for during pre-training. Experiments show that in this way, fewer clinical images are needed to achieve appropriate segmentation quality.

This method can be applied in all applications that include CBCT segmentation, e.g., for image-guided lung, liver, or kidney interventions.

In an embodiment of the invention, the AI module is trained with the training data using a supervised or a semi-supervised training algorithm. The two main approaches for training an AI-based registration or segmentation algorithm. i.e., supervised or semi-supervised, can be followed depending on the target application and data availability.

According to another aspect of various embodiments, there is provided a data processing apparatus comprising a processor configured to perform the steps of the method according to any of the preceding embodiments.

According to another aspect of various embodiments, there is provided a computer program comprising instructions which, when the program is executed by a computer, cause the computer to carry out the steps of the method according to any of the preceding embodiments. The computer program element can be performed on one or more processing units, which are instructed to perform the method according to any of the preceding embodiments.

According to another aspect of various embodiments, there is provided a computer-readable storage medium comprising instructions which, when executed by a computer, cause the computer to carry out the steps of the method according to any of the preceding embodiments. The computer-readable storage medium is non-transient.

The present application relates to a computer-implemented method for generating a simulated CBCT image based on a computed tomography image. In some embodiments, a computed tomography image is converted into attenuation coefficients of the represented tissue, and the computed tomography image is forward-projected to a projection image based on scanner parameters, which may be predetermined, of a simulated CBCT scanner. In some embodiments, the attenuation coefficients can be used for the forward projection. For example, such coefficients may be used to create the raw data. The representation of the raw data itself can be in different units (e.g., attenuation/line integral space). The units for the representation of the raw data depend on the type of noise that is desired to be added in subsequent step(s).

After the addition of artificial noise to the projection image representing noise detected by the simulated CBCT scanner, the projection image is back-projected with a reconstruction algorithm for the generation of a simulated CBCT image of the subject. The present application relates further to a method for generating training data for training an AI module based on the simulated images, and to methods for registering a computed tomography image to a CBCT image and for segmenting a CBCT image with an AI module trained with training data comprising the simulated CBCT images.

One of the advantages of various embodiments described in the present application is that the algorithm can simulate CBCT images from CT images.

Another advantage of some embodiments is that it is possible to omit simulating the General Adversarial Network (GAN) simulation, which allows to speed up the process of simulation with improved quality of simulations.

Another advantage of various embodiments may be that it would be possible to simulate the CBCT images near real-time omitting the lag in simulation.

These advantages are non-limiting and other advantages may be envisioned within the context of the present application.

The above aspects and embodiments will become apparent from and be elucidated with reference to the exemplary embodiments described hereinafter. Example embodiments will be described in the following with reference to the following drawings;

### BRIEF DESCRIPTION OF THE DRAWINGS

FIG. 1 shows a block diagram of a computer-implemented method for generating a simulated CBCT image based on a computed tomography image according to an embodiment of the invention.

FIG. 2 shows example images of generated simulated CBCT scans based on a CT scan using different parameter settings.

FIG. 3 shows a block diagram of a computer-implemented method for generating training data for training of an AI module to register a CBCT image to a computed tomography image according to an embodiment.

FIGS. 4a and 4b show block diagram of the two strategies for generating training data sets and for training an AI-based CT-to-CBCT registration algorithm.

FIG. 5 shows a block diagram of a computer-implemented method for registering a computed tomography image to a CBCT image according to an embodiment.

FIG. 6 shows a block diagram of a computer-implemented method for segmenting a CBCT image according to an embodiment.

FIG. 7 shows an automatic kidney segmentation of a clinical CBCT scan.

### DETAILED DESCRIPTION OF EMBODIMENTS

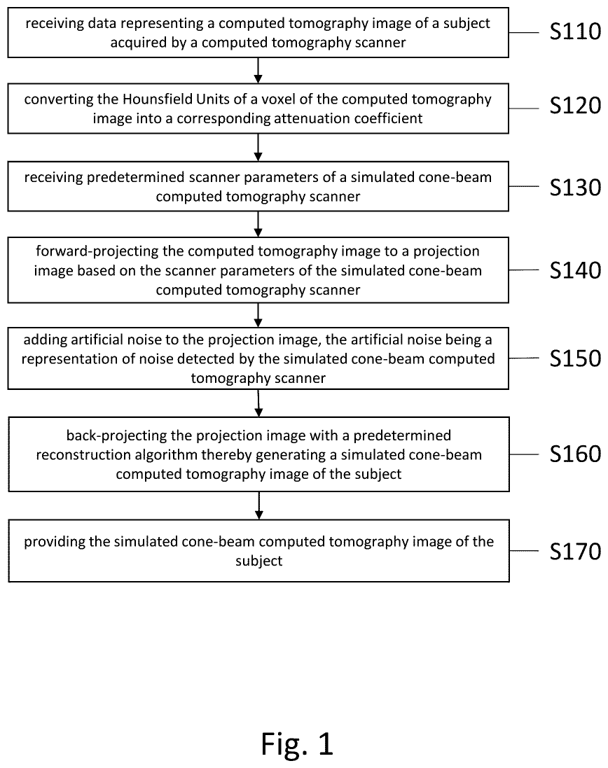

FIG. 1 shows a block diagram of a computer-implemented method for generating a simulated CBCT image based on a computed tomography image according to an embodiment of the invention. The method comprises the steps S110 of receiving data representing a computed tomography image of a subject acquired by a computed tomography scanner, the computed tomography image comprising a volume of the subject being divided into a plurality of voxels, the voxels comprising a representation of a tissue property of a tissue of the subject in Hounsfield Units, and the step S120 of converting the Hounsfield Units of a voxel of the computed tomography image into a corresponding attenuation coefficient. The method comprises further the step S130 of receiving scanner parameters, which may be predetermined, of a simulated CBCT scanner, the step S140 of forward-projecting the computed tomography image to a projection image based on the scanner parameters of the simulated CBCT scanner, and the step S150 of adding artificial noise to the projection image, the artificial noise being a representation of noise detected by the simulated CBCT scanner. The method further comprises the step S160 of back-projecting the projection image with a reconstruction algorithm thereby generating a simulated CBCT image of the subject. Examples of reconstruction algorithms include, for example, distributed compressed sensing (DCS), or Feldkamp-David-Kress (FDK), or other similar algorithms. The method further comprises the step S170 of providing the simulated CBCT image of the subject.

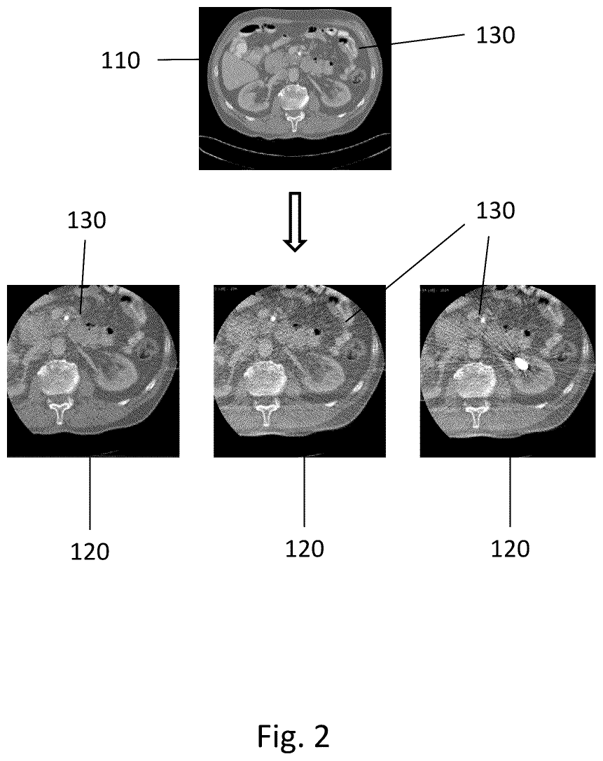

FIG. 2 shows exemplary images of generated simulated CBCT scans 120 of a subject 130 based on a CT scan 110 using different parameter settings. The upper image is a CT image acquired with a computed tomography scanner. The three images in the lower row show simulated CBCT images 120 based on the CT image 110, which are generated with the method according to an embodiment of the invention. The image on the left is a generated simulated CBCT image with a field-of-view constraint, whereas the image in the middle comprise additional limited angle artefacts. The image on the right shows additional iodine beam hardening artefacts due to the urinary outflow tract being filled with a contrast agent.

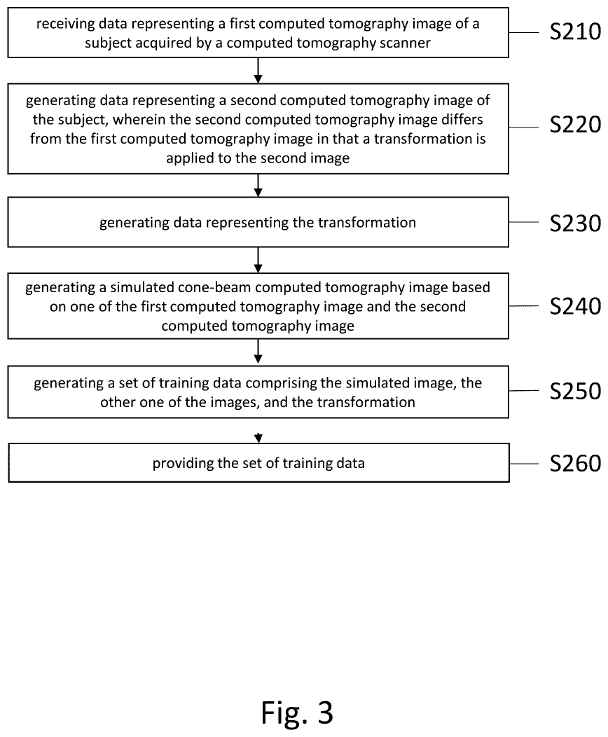

FIG. 3 shows a block diagram of a computer-implemented method for generating training data for training of an artificial intelligence (AI) module to register a CBCT image to a computed tomography image according to an example embodiment. The method comprises the step S210 of receiving data representing a first CT image of a subject acquired by a CT scanner, and the step S220 of generating data representing a second CT image of the subject, wherein the second CT image differs from the first CT image in that a transformation is applied to the second image, the transformation comprising a deformation, distortion, rotation, and/or translation of the subject, and/or a cropped field of view, and the step S230 of generating data representing the transformation. The method comprises further the step S240 of generating a simulated CBCT image based on one of the first CT image and the second CT image according to the method of any of the preceding embodiments, and the step S50 of generating a set of training data, the set of training data comprising the simulated CBCT image based on one of the first CT image and the second CT image, the other one of the first CT image and the second CT image, and data representing the transformation. Further, the set of training data is provided in step S260.

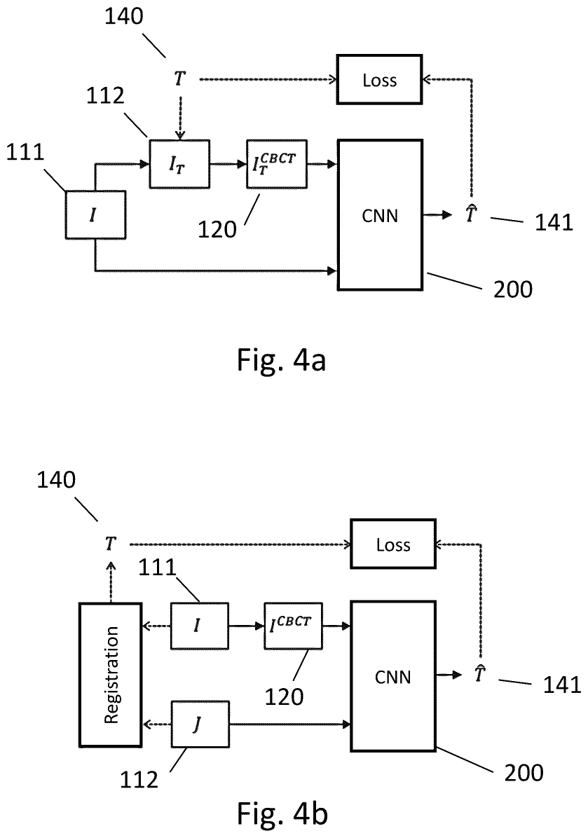

FIGS. 4a and 4b show block diagrams of the two strategies for generating training data sets and for training an AI-based CT-to-CBCT registration algorithm. In FIG. 4a, an artificial transformation T is applied to transform the image I to IT before the simulation I_{T}^{CBCT}:=(I∘T) CBCT is performed to generate a simulated CBCT image. Both images, I and I_{T}^{CBCT} are feed to the convolutional neural network CNN as algorithm to be trained to estimate T′ based on I and I_{T}^{CBCT}. A loss function is determined based on T and T′ for a supervised learning.

In FIG. 4b, two images I and J are provided, and a real transformation T is determined. In this example, the image I is used to generate the simulated CBCT image I^{CBCT}. Both images, I^{CBCT} and J are feed to the convolutional neural network CNN as algorithm to be trained to estimate T′ based on J and I CBCT. A loss function is determined based on T and T′ for a supervised learning.

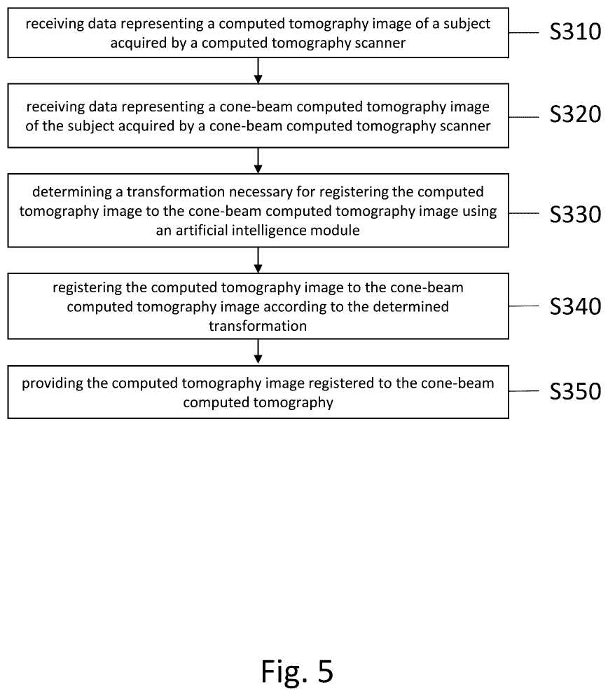

FIG. 5 shows a block diagram of a computer-implemented method for registering a computed tomography image to a CBCT image according to an embodiment of the invention. The method comprises the step S310 of receiving data representing a computed tomography image of a subject acquired by a computed tomography scanner, the step S320 of receiving data representing a CBCT image of the subject acquired by a CBCT scanner, and the step S330 of determining a transformation necessary for registering the computed tomography image to the CBCT image using an AI module, wherein the AI module is trained with training data generated with the method according to any of the preceding embodiments. The method comprises further the step S340 of registering the computed tomography image to the CBCT image according to the determined transformation, and the step S350 of providing the computed tomography image registered to the CBCT.

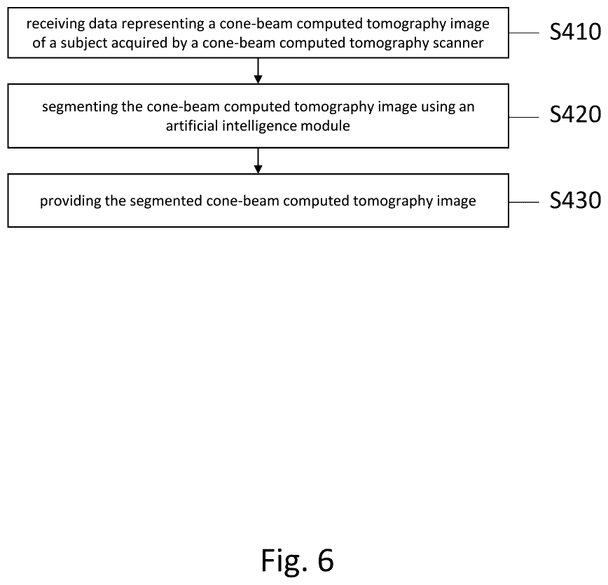

FIG. 6 shows a block diagram of a computer-implemented method for segmenting a CBCT image according to an embodiment. The method comprises the step S410 of receiving data representing a CBCT image of a subject acquired by a CBCT scanner, the step S420 of segmenting the CBCT image using an AI module, wherein the AI module is trained with training data comprising a plurality of simulated CBCT images generated with the method according to any of the preceding embodiments, and the step S430 of providing the segmented CBCT image.

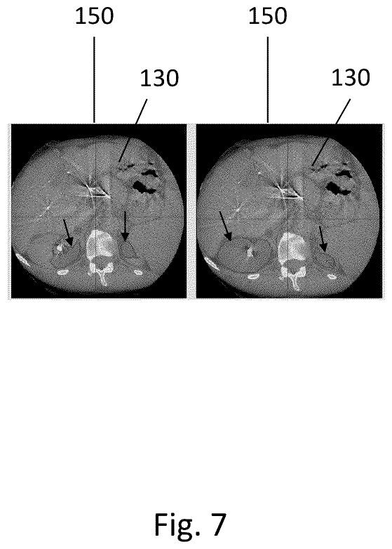

FIG. 7 shows an automatic kidney segmentation of a clinical CBCT scan. The left image 150 shows a segmentation result of an algorithm trained on CT data only that fails to segment the kidney of the subject 130 in the CBCT image correctly, as can be seen in the dark edging in the lower part of the image. The black arrows indicate the dark edging that is used to visualize the segmentation result of the kidneys of the subject 130. The right image 150 shows a segmentation result of an algorithm that was trained on CT and simulated CBCT data that therefore performs significantly better, even though no clinical CBCT data was used during this training procedure. In this image, the dark edging covers the whole area of the kidneys. In our experiments, the CT-only model achieved a Dice of 0.49 when applied to a set of 45 CBCT images, whereas the CT/simulated CBCT model achieved a Dice of 0.65.

When certain embodiments of the invention described herein are implemented at least in part with software (including firmware), such embodiments provide for a computer program product comprising a set of instructions executable by a processor that causes the processor to perform the method of any of the previously described embodiments of the method. It should be further noted that the software may be stored on a variety of non-transitory computer-readable (storage) medium for use by, or in connection with, a variety of computer-related systems or methods. In the context of this document, a computer-readable storage medium may comprise an electronic, magnetic, optical, or other physical device or apparatus that may contain or store a computer program (e.g., executable code or instructions) for use by or in connection with a computer-related system or method. The software may be embedded in a variety of computer-readable storage mediums for use by, or in connection with, an instruction execution system, apparatus, or device, such as a computer-based system, processor-containing system, or other system that can fetch the instructions from the instruction execution system, apparatus, or device and execute the instructions.

When certain embodiments of the invention described herein are implemented at least in part with hardware, such functionality may be implemented with any or a combination of the following technologies, which are all well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), relays, contactors, etc.

Some embodiments may include a computing device, for example, that comprises at least one memory and at least one processor (i.e., processing unit). The memory may include any one or a combination of volatile memory elements (e.g., random-access memory RAM, such as DRAM, and SRAM, etc.) and nonvolatile memory elements (e.g., ROM, Flash, solid state, EPROM, EEPROM, hard drive, tape, CDROM, etc.). The memory may store a native operating system, one or more native applications, emulation systems, or emulated applications for any of a variety of operating systems and/or emulated hardware platforms, emulated operating systems, etc. In some embodiments, a separate storage device may be coupled to the data bus or as a network-connected device. The storage device may be embodied as persistent memory (e.g., optical, magnetic, and/or semiconductor memory and associated drives). The memory comprises an operating system (OS) and application software, including the software implementing the methods described herein.

Execution of the application software may be implemented by one or more processors under the management and/or control of the operating system. The processor (i.e., processing unit) may be embodied as a custom-made or commercially available processor, a central processing unit (CPU) or an auxiliary processor among several processors, a semiconductor-based microprocessor (in the form of a microchip), a macroprocessor, one or more application specific integrated circuits (ASICs), a plurality of suitably configured digital logic gates, and/or other well-known electrical configurations comprising discrete elements both individually and in various combinations to coordinate the overall operation of the computing device.

Note that the methods described above and associated functionality may be implemented as part of a server network or cloud computing environment that serves one or more clinical and/or research facilities. When implemented as part of a cloud service or services, one or more computing devices may comprise an internal cloud, an external cloud, a private cloud, or a public cloud (e.g., commercial cloud). For instance, a private cloud may be implemented using a variety of cloud systems including, for example, Eucalyptus Systems, VMWare vSphere®, or Microsoft® HyperV. A public cloud may include, for example, Amazon EC2®, Amazon Web Services®, Terremark®, Savvis®, or GoGrid®. Cloud-computing resources provided by these clouds may include, for example, storage resources (e.g., Storage Area Network (SAN), Network File System (NFS), and Amazon S3®), network resources (e.g., firewall, load-balancer, and proxy server), internal private resources, external private resources, secure public resources, infrastructure-as-a-services (IaaSs), platform-as-a-services (PaaSs), or software-as-a-services (SaaSs). The cloud architecture of the computing devices may be embodied according to one of a plurality of different configurations. For instance, if configured according to MICROSOFT AZURE™, roles are provided, which are discrete scalable components built with managed code. Worker roles are for generalized development, and may perform background processing for a web role. Web roles provide a web server and listen for and respond to web requests via an HTTP (hypertext transfer protocol) or HTTPS (HTTP secure) endpoint. VM roles are instantiated according to tenant defined configurations (e.g., resources, guest operating system). Operating system and VM updates are managed by the cloud. A web role and a worker role run in a VM role, which is a virtual machine under the control of the tenant. Storage and SQL services are available to be used by the roles. As with other clouds, the hardware and software environment or platform, including scaling, load balancing, etc., are handled by the cloud.

In some embodiments, computing devices used in the implementation of the disclosed embodiments may be configured into multiple, logically-grouped servers (run on server devices), referred to as a server farm. The computing devices may be geographically dispersed, administered as a single entity, or distributed among a plurality of server farms. The computing devices within each farm may be heterogeneous. One or more of the computing devices may operate according to one type of operating system platform (e.g., WINDOWS NT, manufactured by Microsoft Corp. of Redmond, Wash.), while one or more of the computing devices may operate according to another type of operating system platform (e.g., Unix or Linux). The computing devices may be logically grouped as a farm that may be interconnected using a wide-area network (WAN) connection or medium-area network (MAN) connection. The computing devices may each be referred to as, and operate according to, a file server device, application server device, web server device, proxy server device, or gateway server device.

Note that cooperation between devices (e.g., clinician computing devices) of other networks and the devices of the cloud (and/or cooperation among devices of the cloud) may be facilitated (or enabled) through the use of one or more application programming interfaces (APIs) that may define one or more parameters that are passed between a calling application and other software code such as an operating system, library routine, and/or function that provides a service, that provides data, or that performs an operation or a computation. The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer employs to access functions supporting the API. In some implementations, an API call may report to an application the capabilities of a device running the application, including input capability, output capability, processing capability, power capability, and communications capability.

As should be appreciated by one having ordinary skill in the art, one or more computing devices of the cloud platform (or other platform types), as well as of other networks communicating with the cloud platform, may be embodied as an application server, computer, among other computing devices.

In that respect, one or more of the computing devices comprises one or more processors, input/output (I/O) interface(s), one or more user interfaces (UI), which may include one or more of a keyboard, mouse, microphone, speaker, tactile device (e.g., comprising a vibratory motor), touch screen displays, etc., and memory, all coupled to one or more data busses.

Examples of visual display devices include a light-emitting diode (LED) display, a liquid crystal display (LCD), a cathode ray tube (CRT), a vacuum fluorescent display (VFD), a sheet of electronic paper, and other display devices. In some embodiments, visual display devices include a backlight to assist a user in viewing the visual display device in poorly lit environments. Examples of audible output devices include a speaker, headset, buzzer, alarm, and other output devices. In some embodiments, an audible output device provides an alert to a user.

Further, each method claim may be performed by a computing device, system, or by a non-transitory computer readable medium.

The computing device may include memory in the form of a non-transitory computer readable medium, or may include one or more each of a memory and a non-transitory computer readable medium. A single processor or other unit may fulfill the functions of several items recited in the claims. The mere fact that certain measures are recited in mutually different dependent claims does not indicate that a combination of these measures cannot be used to advantage. A computer program may be stored/distributed on a suitable medium, such as an optical medium or solid-state medium supplied together with or as part of other hardware, but may also be distributed in other forms.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

While various embodiments of the invention have been illustrated and described in detail in the drawings and foregoing description, such illustration and description are to be considered illustrative or examples and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the 10 indefinite article “a” or “an” does not exclude a plurality. The mere fact that certain measures are re-cited in mutually different dependent claims does not indicate that a combination of these measures cannot be used to advantage. Any reference signs in the claims should not be construed as limiting the scope.

### LIST OF REFERENCE SIGNS

110 computed tomography image
111 first computed tomography image
112 second computed tomography image
120 simulated cone-beam computed tomography image
130 subject
140 transformation
141 determined transformation
150 segmented cone-beam computed tomography image
200 artificial intelligence module

1. A computer-implemented method for generating a simulated cone-beam computed tomography (CBCT) image based on a computed tomography image, the method comprising the steps of:
receiving data representing a CT image comprising a volume of a subject, wherein the volume is divided into voxels, wherein the voxels comprise a representation of a tissue property of a tissue of the subject in a Hounsfield Unit;
converting the Hounsfield Unit of the CT image into attenuation coefficients:
receiving scanner parameters of a simulated CBCT scanner,
forward-projecting the CT image to a projection image based on the scanner parameters of the simulated CBCT scanner;
adding artificial noise to the projection image, the artificial noise is a representation of noise detected by the simulated CBCT scanner;
back-projecting the projection image with a reconstruction algorithm, thereby generating a simulated CBCT image of the subject; and
providing the simulated CBCT image of the subject.

2. The method of claim 1, wherein the method further comprises the step of modifying the tissue property of the tissue of the subject.

3. The method of claim 1, wherein the scanner parameters comprise at least two tube peak voltages of the simulated CBCT scanner.

4. The method of claim 1, wherein the computed tomography image is a fan-beam computed tomography image or a CBCT image.

5. A computer-implemented method for generating training data for training of an artificial intelligence module to register a CBCT image to a computed tomography image, the method comprising the steps of:
receiving data representing a first computed tomography image of a subject;
generating data representing a second computed tomography image of the subject, wherein the second computed tomography image differs from the first computed tomography image in that a transformation is applied to the second computed tomography image, the transformation comprising a deformation, and/or distortion, and/or rotation, and/or translation of the subject, and/or a cropped field of view;
generating data representing the transformation;
generating a simulated CBCT image based on one of the first computed tomography image and the second computed tomography image according to the method of claim 1, wherein the data representing the computed tomography image comprises the first and/or the second computed tomography image;
generating a set of training data, the set of training data comprising the simulated CBCT image based on one of the first computed tomography image and the second computed tomography image, the other one of the first computed tomography image and the second computed tomography image, and data representing the transformation; and
providing the set of training data.

6. The method of claim 5, wherein the generating data representing a second computed tomography image of the subject comprises receiving data representing the second computed tomography image of the subject acquired by a computed tomography scanner.

7. The method of claim 6, wherein the generating data representing the transformation comprises registering the first computed tomography image to the second computed tomography image.

8. The method of claim 7, wherein the registering of the first computed tomography image to the second computed tomography image is performed with a registering algorithm or an AI-based registering algorithm.

9. The method of claim 5, wherein the generating data representing a second computed tomography image of the subject comprises applying an artificial transformation to the data representing the first computed tomography image of the subject thereby generating data representing the second computed tomography image of the subject.

10. The method of claim 9, wherein the step of generating data representing the transformation comprises receiving data representing the artificial transformation.

11. A computer-implemented method for registering a computed tomography image to a CBCT image, the method comprising:
receiving data representing a computed tomography image of a subject;
receiving data representing a CBCT image of the subject;
determining a transformation necessary for registering the computed tomography image to the CBCT image using an artificial intelligence module,
wherein the artificial intelligence module is trained with training data generated with the method of claim 5;
registering the computed tomography image to the CBCT image according to the determined transformation; and
providing the computed tomography image registered to the CBCT.

12. A computer-implemented method for segmenting a CBCT image, the method comprising the steps of:
receiving data representing a CBCT image of a subject acquired by a CBCT scanner;
segmenting the CBCT image using an artificial intelligence module,
wherein the artificial intelligence module is trained with training data comprising a plurality of simulated CBCT images generated with the method according to claim 1; and
providing the segmented CBCT image.

13. The method of claim 12, wherein the training data comprises a plurality of CT images acquired with a computed tomography scanner and/or a plurality of CBCT images acquired with a CBCT scanner.

14. The method of claim 11, wherein the artificial intelligence module is trained with the training data using a supervised or a semi-supervised training algorithm.

15. A non-transient computer readable medium comprising instructions which, when the program is executed by a computer, cause the computer to carry out the steps of the method of claim 1.

16. The method of claim 1, wherein the forward projecting is based on the attenuation coefficients.

17. The method of claim 1, wherein the forward projecting includes creating raw data based on the attenuation coefficients.
